(19) United States
(12) Patent Application Publication
(10) Pub. No.: US 2023/0335090 A1
(43) Pub. Date: Oct. 19, 2023

(54) INFORMATION PROCESSING DEVICE, INFORMATION PROCESSING METHOD, AND PROGRAM

(71) Applicant: SONY GROUP CORPORATION, TOKYO (JP)

(72) Inventor: YUKARA IKEMIYA, TOKYO (JP)

(21) Appl. No.: 18/245,351

(22) PCT Filed: Aug. 17, 2021
(86) PCT No.: PCT/JP2021/030000

§ 371 Date: Mar. 15, 2023

(30) Foreign Application Priority Data
Sep. 29, 2020 (JP) 2020-164089

(51) Int. Cl. G10H 1/00

(52) U.S. Cl. CPC G10H 1/0008; G10H 2210/091; G10H 2210/056

(57) ABSTRACT

To appropriately generate evaluation data to be compared with user input data. An information processing device includes a comparison unit that compares evaluation data generated on the basis of first user input data with second user input data.

### TECHNICAL FIELD

The present disclosure relates to an information processing device, an information processing method, and a program.

### BACKGROUND ART

A device that evaluates data (hereinafter, referred to as user input data) input according to an action of a user is known. For example, the following Patent Document 1 describes a singing evaluation device that evaluates user singing data obtained according to user's singing.

### CITATION LIST

### Patent Document

Patent Document 1: Japanese Patent Application Laid-Open No. 2001-117568

### SUMMARY OF THE INVENTION

### Problems to be Solved by the Invention

In this field, it is desired to perform processing for appropriately evaluating user input data.

An object of the present disclosure is to provide an information processing device, an information processing method, and a program that perform processing for appropriately evaluating user input data.

### Solutions to Problems

The present disclosure provides, for example, an information processing device including a comparison unit that compares evaluation data generated on the basis of first user input data with second user input data.

The present disclosure provides, for example, an information processing method in which a comparison unit compares evaluation data generated on the basis of first user input data with second user input data.

The present disclosure provides, for example, a program for causing a computer to execute an information processing method in which a comparison unit compares evaluation data generated on the basis of first user input data with second user input data.

The present disclosure provides, for example,
an information processing device including:
a feature amount extraction unit that extracts a feature amount of user input data; and
an evaluation data generation unit that generates evaluation data for evaluating the user input data on the basis of the feature amount of the user input data.

The present disclosure provides, for example,
an information processing method
in which a feature amount extraction unit extracts a feature amount of user input data, and
an evaluation data generation unit generates evaluation data for evaluating the user input data on the basis of the feature amount of the user input data.

The present disclosure provides, for example,
a program for causing a computer to execute an information processing method
in which a feature amount extraction unit extracts a feature amount of user input data, and
an evaluation data generation unit generates evaluation data for evaluating the user input data on the basis of the feature amount of the user input data.

### BRIEF DESCRIPTION OF DRAWINGS

FIG. 1 is a block diagram illustrating a configuration example of an information processing device according to a first embodiment.

FIG. 2 is a block diagram illustrating a configuration example of a first feature amount extraction unit according to the first embodiment.

FIG. 3 is a diagram to be referred to when an evaluation data candidate generation unit according to the first embodiment is described.

FIG. 4 is a block diagram illustrating a configuration example of a second feature amount extraction unit according to the first embodiment.

FIG. 5 is a block diagram illustrating a configuration example of the evaluation data generation unit according to the first embodiment.

FIGS. 6A to 6C are diagrams to be referred to when the evaluation data generation unit according to the first embodiment is described.

FIG. 7 is a block diagram illustrating a configuration example of a user singing evaluation unit according to the first embodiment.

FIG. 8 is a flowchart for describing an operation example of the information processing device according to the first embodiment.

FIG. 9 is a diagram for describing a second embodiment.

FIG. 10 is a diagram for describing the second embodiment.

### MODE FOR CARRYING OUT THE INVENTION

Hereinafter, embodiments and the like of the present disclosure will be described with reference to the drawings. Note that the description will be given in the following order.

### Problems to Be Considered in the Present Disclosure

### First Embodiment

### Second Embodiment

### Modification

The embodiments and the like described below are preferred specific examples of the present disclosure, and the content of the present disclosure is not limited to these embodiments and the like.

### Problems to Be Considered in the Present Disclosure

First, in order to facilitate understanding of the present disclosure, problems to be considered in the present disclosure will be described with reference to the background of the present disclosure.

Systems that automatically evaluate and score user's singing or playing a musical instrument by a machine are often used in karaoke for entertainment and applications for improving playing a musical instrument. For example, a basic mechanism of a system for evaluating musical instrument performance uses correct performance data representing correct performance as evaluation data, compares the correct performance data with user performance data extracted from the user's performance to measure a degree of matching, and performs evaluation according to the degree of matching.

For example, in a case of singing or a musical instrument having a pitch such as a guitar or a violin, musical score information and pitch time track information temporally synchronized with the accompaniment or the tempo of the music to be played may be used as correct performance data, a pitch track extracted from the musical instrument sound played by the user may be used as user performance data, a degree of deviation therebetween is calculated, and evaluation according to the calculation result is performed. Furthermore, volume track information indicating a temporal change in volume may be used as correct data in addition to the pitch track. Furthermore, for a musical instrument that does not have a pitch that can be controlled by the user, such as a drum or the like, a difference in hitting timing, a strength of hitting, and a volume are often used as data for evaluation.

Since the correct performance data needs to correctly express the performance targeted by the user, annotation of pitch or the like is manually performed from the original musical composition, and the correct performance data is often stored as musical score information such as musical instrument digital interface (MIDI) data. However, it takes a lot of labor to manually create correct performance data such as a large number of new pieces that are sequentially released or the like, and it takes time to evaluate performance, or music with low priority is often omitted from the target of annotation.

Furthermore, in correct performance data prepared in advance, it is often impossible to express the performance of the original musical composition intended by the user. For example, in a song with chorus singing (harmonizing), a violin duet, or the like, it is necessary to determine which part the user is playing and then use the correct performance data corresponding to the part the user is playing. Otherwise, the user's performance cannot be evaluated correctly. Furthermore, in manual annotation data, fine expressions (for example, vibrato, intonation, and the like) included in the performance of the original musical composition are often omitted, and it is difficult to evaluate these expressions even if the user plays these expressions skillfully. Embodiments of the present disclosure will be described in detail in consideration of the above points.

### First Embodiment

### Configuration Example of Information Processing Device

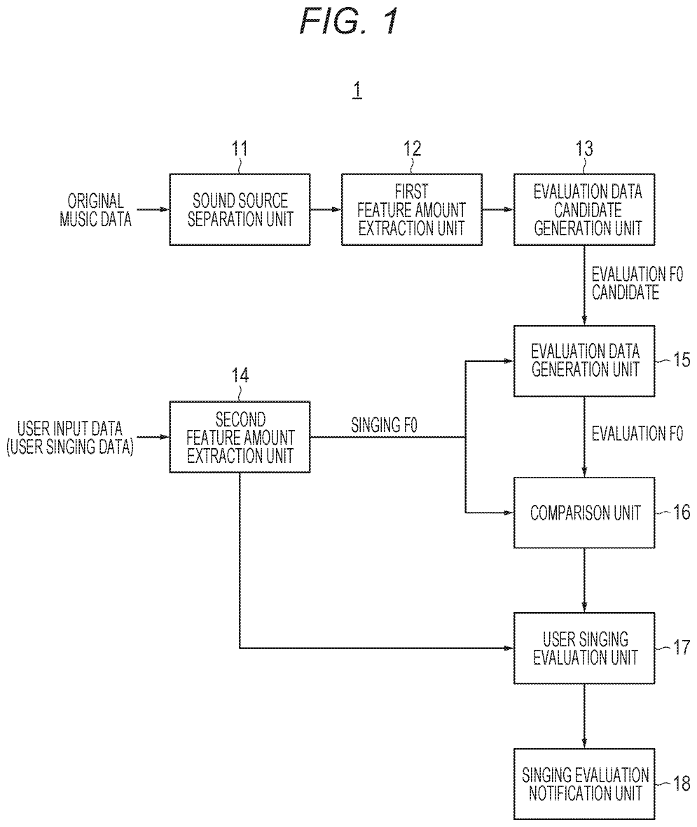

FIG. 1 is a block diagram illustrating a configuration example of an information processing device (information processing device 1) according to a first embodiment. The information processing device 1 according to the present embodiment is configured as a singing evaluation device that evaluates user singing data input according to the user's singing.

As illustrated in FIG. 1, original music data and user singing data are input to the information processing device 1. The original music data is data of the same type as the user singing data, that is, mixed sound data including a vocal signal and a sound signal of a musical instrument. The original music data is input to the information processing device 1 via a network or various media. Note that, in FIG. 1, a communication unit, a media drive, and the like that acquire original music data are not illustrated.

Singing by the user is collected by a sensor such as a microphone, a bone conduction sensor, an acceleration sensor, and the like, and then converted into a digital signal by an analog-to-digital (AD) converter. Note that, in FIG. 1, a sensor that collects the user's singing and an AD converter are not illustrated.

The information processing device 1 includes a sound source separation unit 11, a first feature amount extraction unit 12, an evaluation data candidate generation unit 13, a second feature amount extraction unit 14, an evaluation data generation unit 15, a comparison unit 16, a user singing evaluation unit 17, and a singing evaluation notification unit 18.

The sound source separation unit 11 performs sound source separation on the original music data that is the mixed sound data. As a method of sound source separation, a known sound source separation method can be applied. For example, as a method of sound source separation, the method described in WO 2018/047643 A previously proposed by the applicant of the present disclosure, a method using independent component analysis, or the like can be applied. By the sound source separation performed by the sound source separation unit 11, the original music data is separated into a vocal signal and a sound source signal for each musical instrument. The vocal signal includes signals corresponding to a plurality of parts, such as a main tune part, a harmonizing part, and the like.

The first feature amount extraction unit 12 extracts a feature amount of the vocal signal subjected to sound source separation by the sound source separation unit 11. The extracted feature amount of the vocal signal is supplied to the evaluation data candidate generation unit 13.

The evaluation data candidate generation unit 13 generates a plurality of evaluation data candidates on the basis of the feature amount extracted by the first feature amount extraction unit 12. The plurality of generated candidates for evaluation data is supplied to the evaluation data generation unit 15.

The user singing data of the digital signal is input to the second feature amount extraction unit 14. The second feature amount extraction unit 14 calculates the feature amount of the user singing data. Furthermore, the second feature amount extraction unit 14 extracts data (hereinafter, referred to as singing expression data) corresponding to the singing expression (for example, vibrato or tremolo) included in the user singing data. The feature amount of the user singing data extracted by the second feature amount extraction unit 14 is supplied to the evaluation data generation unit 15 and the comparison unit 16. Furthermore, the singing expression data extracted by the second feature amount extraction unit 14 is supplied to the user singing evaluation unit 17.

The evaluation data generation unit 15 generates evaluation data (correct data) to be compared with the user singing data. For example, the evaluation data generation unit 15 generates the evaluation data by selecting one piece of evaluation data from the plurality of evaluation data candidates supplied from the evaluation data candidate generation unit 13 on the basis of the feature amount of the user singing data extracted by the second feature amount extraction unit 14.

The comparison unit 16 compares the user singing data with the evaluation data. More specifically, the comparison unit 16 compares the feature amount of the user singing data with the evaluation data generated on the basis of the feature amount of the user singing data. The comparison result is supplied to the user singing evaluation unit 17.

The user singing evaluation unit 17 evaluates the user's singing proficiency on the basis of the comparison result by the comparison unit 16 and the singing expression data supplied from the second feature amount extraction unit 14. The user singing evaluation unit 17 scores the evaluation result and generates a comment, an animation, or the like corresponding to the evaluation result.

The singing evaluation notification unit 18 is a device that displays the evaluation result of the user singing evaluation unit 17. Examples of the singing evaluation notification unit 18 include a display, a speaker, and a combination thereof, for example. Note that the singing evaluation notification unit 18 may be a separate device from the information processing device 1. For example, the singing evaluation notification unit 18 may be a tablet terminal, a smartphone, or a television device owned by the user, or may be a tablet terminal or a display provided in a karaoke bar.

Note that, in the present embodiment, the singing F0 (F zero) expressing the pitch of the singing is used as the numerical data to be evaluated and the evaluation data. F0 represents a fundamental frequency. Furthermore, since F0 changes for each time, F0 of each time arranged in time series is appropriately referred to as an F0 track. The F0 track is obtained, for example, by performing smoothing processing in the time direction on continuous temporal change of F0. The smoothing processing is performed, for example, by applying a moving average filter.

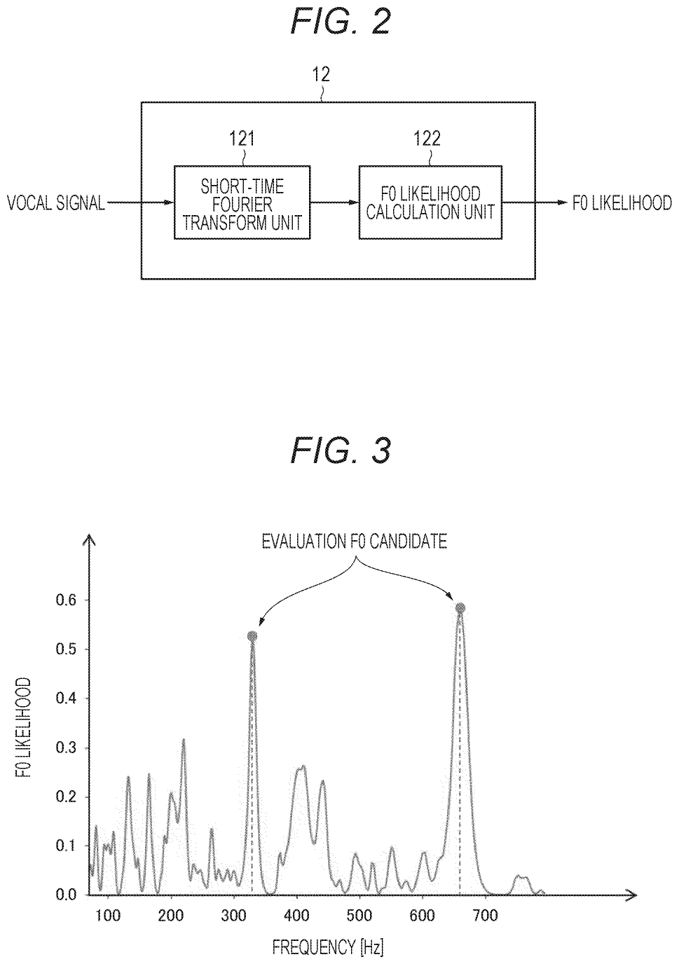

(First Feature Amount Extraction Unit) Next, a detailed configuration example of each unit of the information processing device 1 and processing to be executed will be described. FIG. 2 is a block diagram illustrating a detailed configuration example of the first feature amount extraction unit 12. The first feature amount extraction unit 12 includes a short-time Fourier transform unit 121 and an F0 likelihood calculation unit 122.

The short-time Fourier transform unit 121 cuts out a certain length from the waveform of the vocal signal subjected to the AD conversion processing, and applies a window function such as a Hanning window, a Hamming window, or the like to the cut out length. This cut-out unit is referred to as a frame. A short-time frame spectrum of each time of the vocal signal is calculated by applying a short-time Fourier transform to data for one frame. Note that there may be overlap between the frames to be cut out, and in this way, the change in the signal in the time-frequency domain is smoothed between consecutive frames.

The F0 likelihood calculation unit 122 calculates the F0 likelihood representing the F0 likeness of each frequency bin for each spectrum obtained by the processing of the short-time Fourier transform unit 121. For example, sub-harmonic summation (SHS) can be applied to the calculation of the F0 likelihood. The SHS is a method of determining the fundamental frequency at each time by calculating the sum of the power of the harmonic components for each of the candidates of the fundamental frequency. In addition, a known method such as a method of separating the singing from the spectrogram obtained by the short-time Fourier transform by the robust principal component analysis, and estimating F0 by the Viterbi search using the SHS for the separated singing or the like can be used. The F0 likelihood calculated by the F0 likelihood calculation unit 122 is supplied to the evaluation data candidate generation unit 13.

(Evaluation Data Candidate Generation Unit)

The evaluation data candidate generation unit 13 refers to the F0 likelihood supplied from the F0 likelihood calculation unit 122 and extracts two or more frequencies of F0 for each time to generate candidates for evaluation data. Hereinafter, the candidate for the evaluation data is appropriately referred to as an evaluation F0 candidate.

In a case where N evaluation F0 candidates are extracted, the evaluation data candidate generation unit 13 is only required to select frequencies corresponding to the top N peak positions. Note that the value of N may be set in advance, or may be automatically set to be, for example, the number of parts of a vocal signal obtained as a result of sound source separation by the sound source separation unit 11.

FIG. 3 is a diagram for describing evaluation F0 candidates. In FIG. 3, the horizontal axis represents the frequency, and the vertical axis represents the F0 likelihood calculated by the F0 likelihood calculation unit 122. For example, in a case where N=2, as illustrated in FIG. 3, the evaluation data candidate generation unit 13 sets frequencies (in the example of FIG. 3, around 350 Hz and 650 Hz) corresponding to two peaks having high F0 likelihood as evaluation F0 candidates. The evaluation data candidate generation unit 13 supplies the plurality of evaluation F0 candidates to the evaluation data generation unit 15 (see FIG. 1).

(Second Feature Amount Extraction Unit)

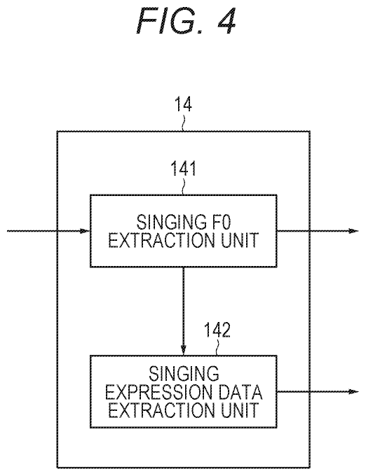

FIG. 4 is a block diagram illustrating a detailed configuration example of the second feature amount extraction unit 14. The second feature amount extraction unit 14 includes a singing F0 extraction unit 141 that extracts user singing data F0 (hereinafter, referred to as singing F0) and a singing expression data extraction unit 142.

The singing F0 extraction unit 141, for example, divides the user singing data into short-time frames, and extracts the singing F0 by a known F0 extraction method for each time frame. As a known F0 extraction method, “M. Morise: Harvest: A high-performance fundamental frequency estimator from speech signals, in Proc. INTERSPEECH, 2017” or “A. Camacho and J. G. Harris, A. sawtooth waveform inspired pitch estimator for speech and music, J. Acoust. Soc. of Am., 2008” can be applied. The extracted singing F0 is supplied to the evaluation data generation unit 15 and the comparison unit 16.

The singing expression data extraction unit 142 extracts the singing expression data. For example, the singing expression data is extracted using the singing F0 track including the singing F0 of several frames extracted by the singing F0 extraction unit 141. As a method of extracting the singing expression data from the singing F0 track, a known method such as a method of extracting the singing expression data based on a difference between the original singing F0 track and the singing F0 track after the smoothing processing is performed, a method of detecting vibrato or the like by performing FFT on the singing F0, a method of visualizing the singing expression data such as vibrato or the like by drawing the singing F0 track in a phase plane, or the like can be applied. The singing expression data extracted by the singing expression data extraction unit 142 is supplied to the user singing evaluation unit 17.

(Evaluation Data Generation Unit)

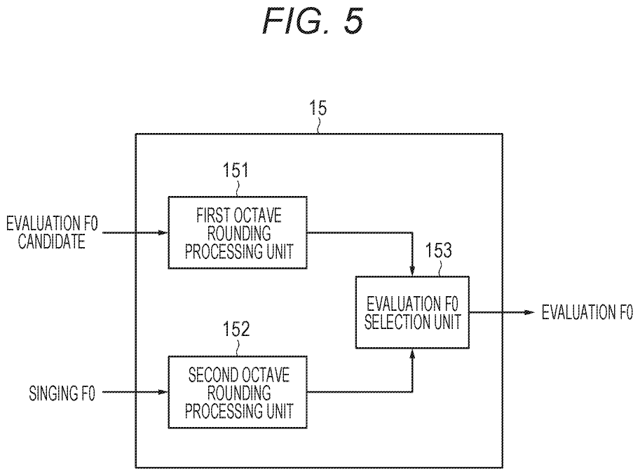

FIG. 5 is a block diagram illustrating a detailed configuration example of the evaluation data generation unit 15. The evaluation data generation unit 15 includes a first octave rounding processing unit 151, a second octave rounding processing unit 152, and an evaluation F0 selection unit 153.

The first octave rounding processing unit 151 performs processing of rounding F0 into one octave in order to correctly evaluate (allow) singing with a difference of one octave for each candidate of the evaluation F0. Here, the rounding processing to each frequency f [Hz] one octave can be performed by the following Formulas 1 and 2.

$$\begin{matrix}[ Mathematical Formula 1 ] & \\ {f}_{note} = {log}_{2} ( \frac{f}{440} ) * 12 + 69 & ( 1 )\end{matrix}$$

$$\begin{matrix}[ Mathematical Formula 2 ] & \\ {f}_{round} = {f}_{note} - floor ( \frac{{f}_{note}}{12} ) * 12 & ( 2 )\end{matrix}$$

f_{round} is obtained by rounding the frequency f into note numbers from 0 to 12, and floor ( ) represents a floor function.

The second octave rounding processing unit 152 performs, on the singing F0, processing of rounding F0 into one octave in order to correctly evaluate (allow) the singing with a difference of one octave. The second octave rounding processing unit 152 performs similar processing to the first octave rounding processing unit 151.

The evaluation F0 selection unit 153 selects the evaluation F0 from the plurality of evaluation F0 candidates on the basis of the singing F0. Usually, the user sings so as to be as close to the pitch or the like of the original music data as possible to obtain a high evaluation. For example, the evaluation F0 selection unit 153 selects the candidate closest to the singing F0 as the evaluation F0 from the plurality of evaluation F0 candidates on the basis of the premise.

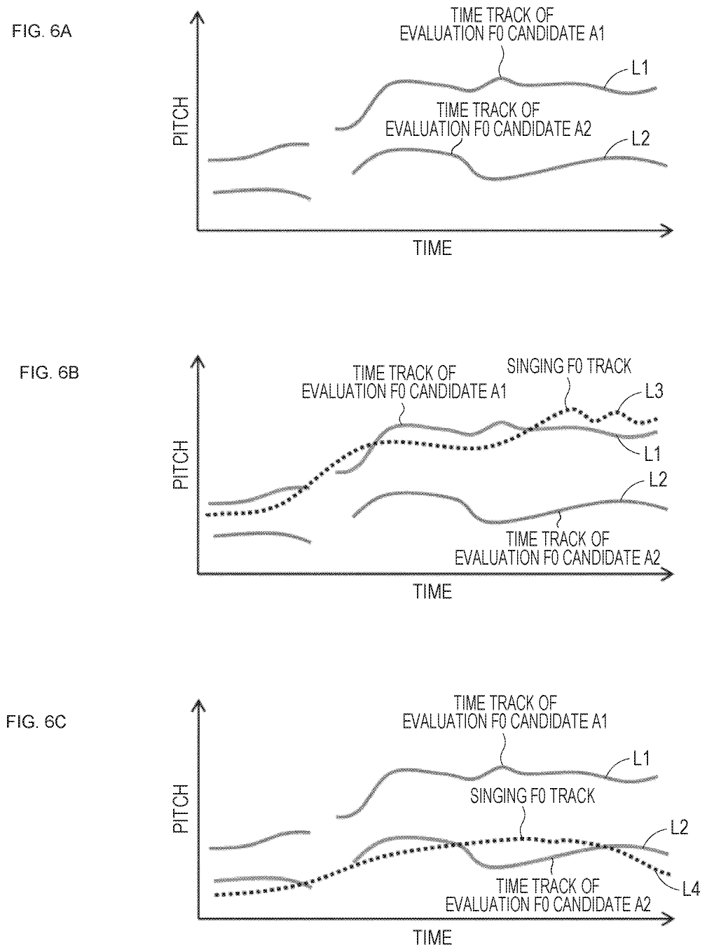

Specific description will be made with reference to FIGS. 6A to 6C. In FIGS. 6A to 6C, the horizontal axis represents time, and the vertical axis represents pitch. For example, in a case where the value of N described above is 2, there are two evaluation F0 candidates. Hereinafter, such two candidates are referred to as an evaluation F0 candidate A1 and an evaluation F0 candidate A2. Specifically, the evaluation F0 candidate A1 is, for example, F0 corresponding to a main tune part, and the evaluation F0 candidate A2 is, for example, F0 corresponding to a harmonizing part. Note that FIGS. 6A to 6C illustrate trajectories indicating temporal changes of F0 extracted in each short-time frame spectrum.

In FIG. 6A, a line L1 indicates a time track of the evaluation F0 candidate A1, and a line L2 indicates a time track of the evaluation F0 candidate A2.

Here, in a case where the singing F0 track is indicated by the line L3 in FIG. 6B, the evaluation F0 selection unit 153 selects the line L1 close to the line L3, namely, the evaluation F0 candidate A1 as the evaluation F0.

Here, in a case where the singing F0 track is indicated by the line L4 in FIG. 6C, the evaluation F0 selection unit 153 selects the line L2 close to the line L4, namely, the evaluation F0 candidate A2 as the evaluation F0. As described above, in the present embodiment, the evaluation data generation unit 15 generates the evaluation F0 by performing selection processing on a plurality of evaluation F0 candidates. The evaluation F0 is supplied to the comparison unit 16.

(Comparison Unit)

The comparison unit 16 compares the singing F0 with the evaluation F0, and supplies a comparison result to the user singing evaluation unit 17. The comparison unit 16 compares the singing F0 and the evaluation F0 obtained for each frame in real time, for example.

(User Singing Evaluation Unit)

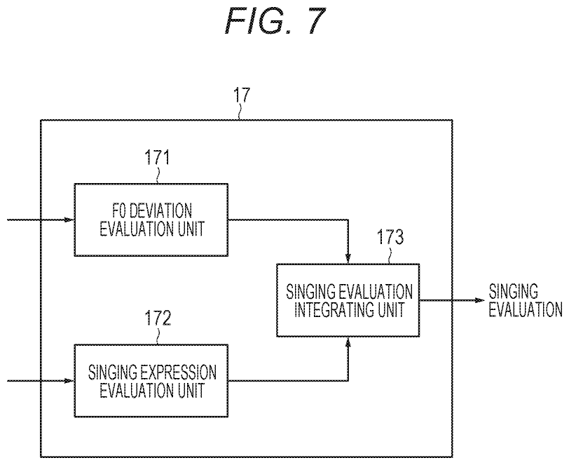

FIG. 7 is a block diagram illustrating a detailed configuration example of the user singing evaluation unit 17. The user singing evaluation unit 17 includes an F0 deviation evaluation unit 171, a singing expression evaluation unit 172, and a singing evaluation integrating unit 173.

The comparison result of the comparison unit 16, for example, the deviation of the singing F0 with respect to the evaluation F0 is supplied to the F0 deviation evaluation unit 171. The F0 deviation evaluation unit 171 evaluates the deviation. For example, the evaluation value is decreased in a case where the deviation is large, and the evaluation value is increased in a case where the deviation is small. The F0 deviation evaluation unit 171 supplies the evaluation value for the deviation to the singing evaluation integrating unit 173.

The singing expression data extracted by the singing expression data extraction unit 142 is supplied to the singing expression evaluation unit 172. The singing expression evaluation unit 172 evaluates the singing expression data. For example, in a case where vibrato or tremolo is extracted as the singing expression data, the singing expression evaluation unit 172 calculates the size, the number of times, the stability, and the like of vibrato or tremolo, and sets the calculation result as an adding factor. The singing expression evaluation unit 172 supplies the evaluation on the singing expression data to the singing evaluation integrating unit 173.

The singing evaluation integrating unit 173, for example, integrates the evaluation by the F0 deviation evaluation unit 171 and the evaluation by the singing expression evaluation unit 172 when the user finishes the singing, and calculates the final singing evaluation on the user's singing. For example, the singing evaluation integrating unit 173 obtains an average of the evaluation values supplied from the F0 deviation evaluation unit 171, and scores the obtained average. Then, a value obtained by adding the adding factor supplied from the singing expression evaluation unit 172 to the score is set as the final singing evaluation. The singing evaluation includes a score, a comment, and the like on the user's singing. The singing evaluation integrating unit 173 outputs the singing evaluation data corresponding to the final singing evaluation.

Note that how to use the deviation of F0 or the singing expression to generate the singing evaluation is not limited to the above method, but a known algorithm can be applied. The singing evaluation notification unit 18 performs display (for example, score display) and audio reproduction (for example, comment reproduction) corresponding to the singing evaluation data.

### Operation Example of Information Processing Device

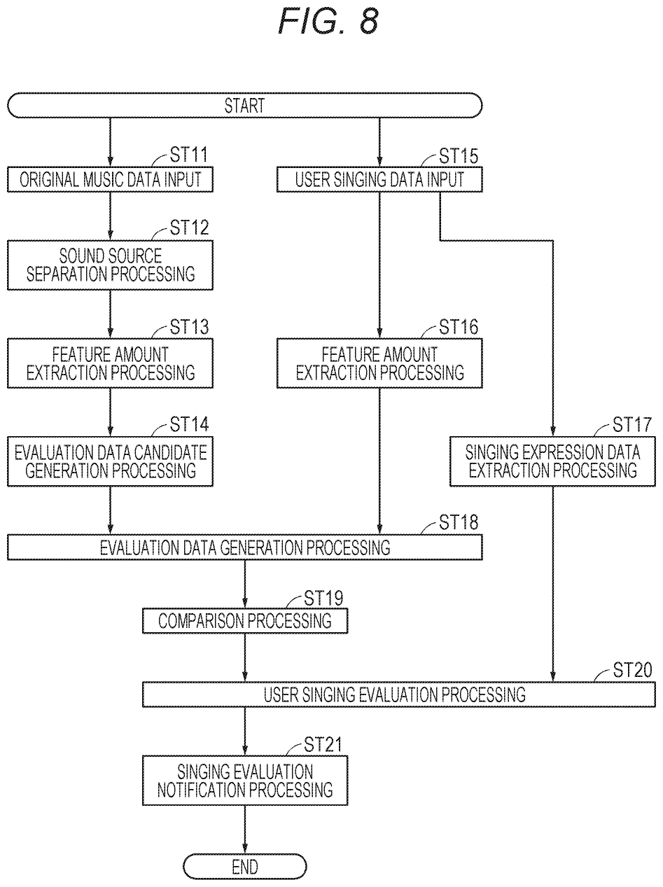

Next, an operation example of the information processing device 1 will be described with reference to the flowchart of FIG. 8. When the karaoke is started, the reproduction of the original music data is started, and the user starts the singing.

When the processing is started, the original music data is input to the information processing device 1 in step ST11. Then, the process proceeds to step ST12.

In step ST12, the sound source separation unit 11 performs sound source separation on the original music data. As a result of the sound source separation, the vocal signal is separated from the original music data. Then, the process proceeds to step ST13.

In step ST13, the first feature amount extraction unit 12 extracts the feature amount of the vocal signal. The extracted feature amount is supplied to the evaluation data candidate generation unit 13. Then, the process proceeds to step ST14.

In step ST14, the evaluation data candidate generation unit 13 generates a plurality of evaluation F0 candidates on the basis of the feature amount supplied from the first feature amount extraction unit 12. The plurality of evaluation F0 candidates is supplied to the evaluation data generation unit 15.

The processing related to steps ST15 to ST18 is performed in parallel with the processing related to steps ST11 to ST14. In step ST15, the user's singing is collected by a microphone or the like, so that the user singing data is input to the information processing device 1. Then, the process proceeds to step ST16.

In step ST16, the second feature amount extraction unit 14 extracts the feature amount of the user singing data. For example, the singing F0 is extracted as the feature amount. The extracted singing F0 is supplied to the evaluation data generation unit 15 and the comparison unit 16.

Furthermore, in step ST17, the second feature amount extraction unit 14 performs the singing expression data extraction processing to extract the singing expression data. The extracted singing expression data is supplied to the user singing evaluation unit 17.

In step ST18, the evaluation data generation unit 15 performs evaluation data generation processing. For example, the evaluation data generation unit 15 generates the evaluation data by selecting the evaluation F0 candidate close to the singing F0. Then, the process proceeds to step ST19.

In step ST19, the comparison unit 16 compares the singing F0 with the evaluation F0 selected by the evaluation data generation unit 15. Then, the process proceeds to step ST20.

In step ST20, the user singing evaluation unit 17 evaluates the user's singing on the basis of the comparison result obtained by the comparison unit 16 and the user singing expression data (user singing evaluation processing). Then, the process proceeds to step ST21.

In step ST21, the singing evaluation notification unit 18 performs the singing evaluation notification processing of providing notification of the singing evaluation generated by the user singing evaluation unit 17. Then, the process ends.

### Effects

According to the present embodiment, for example, the following effects can be obtained.

The evaluation data can be appropriately generated by generating the evaluation data on the basis of the user input data. Therefore, the user input data can be appropriately evaluated. For example, even in a case where a plurality of parts is included, the evaluation data corresponding to the part where the user sings can be generated, so that the singing of the user can be appropriately evaluated. Therefore, this can prevent the user from feeling uncomfortable about the singing evaluation.

In the present embodiment, evaluation data is generated in real time on the basis of user input data. Therefore, this eliminates the need to generate the evaluation data in advance for each of the enormous number of pieces of music. Therefore, labor for introducing the singing evaluation function can be significantly reduced.

### Second Embodiment

Next, a second embodiment will be described. Note that, unless otherwise specified, the same reference numerals are given to the same or similar configurations as those of the first embodiment, and redundant description will be appropriately omitted. The second embodiment is schematically an embodiment in which the functions of the information processing device 1 described in the first embodiment are distributed to a plurality of devices.

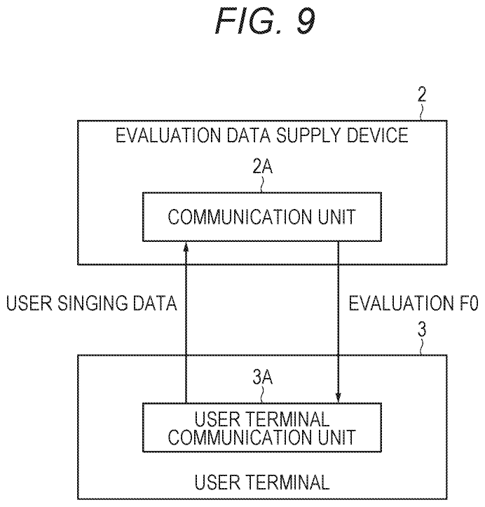

As illustrated in FIG. 9, the present embodiment includes an evaluation data supply device 2 and a user terminal 3. Communication is performed between the evaluation data supply device 2 and the user terminal 3. Communication may be wired or wireless, but in the present embodiment, wireless communication is assumed. Examples of the wireless communication include communication via a network such as the Internet or the like, a local area network (LAN), Bluetooth (registered trademark), Wi-Fi (registered trademark), and the like.

The evaluation data supply device 2 includes a communication unit 2A that performs the above-described communication. Furthermore, the user terminal 3 includes a user terminal communication unit 3A that performs the above-described communication. The communication unit 2A and the user terminal communication unit 3A include a modulation/demodulation circuit, an antenna, and the like corresponding to a communication system.

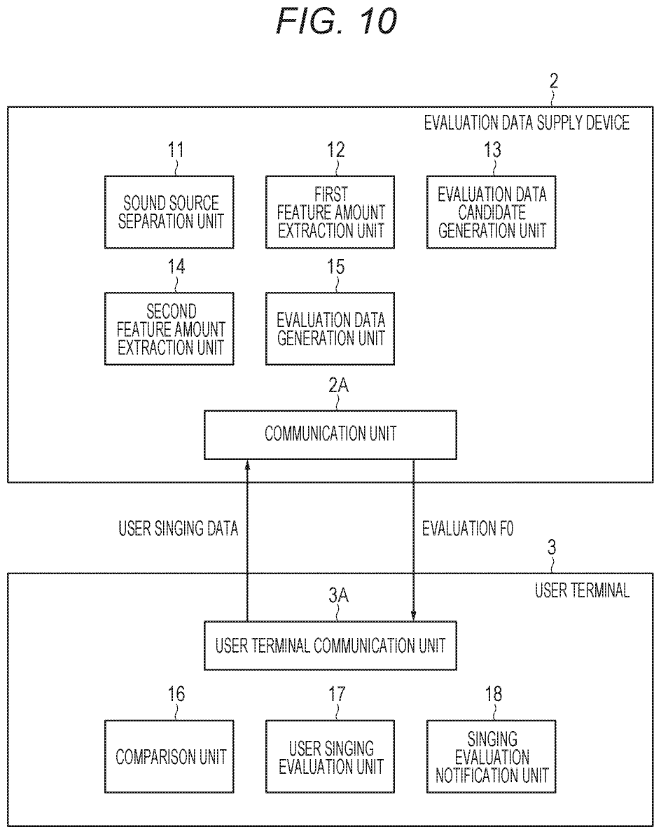

As illustrated in FIG. 10, the evaluation data supply device 2 includes, for example, a sound source separation unit 11, a first feature amount extraction unit 12, an evaluation data candidate generation unit 13, a second feature amount extraction unit 14, and an evaluation data generation unit 15. Furthermore, the user terminal 3 includes a comparison unit 16, a user singing evaluation unit 17, and a singing evaluation notification unit 18.

For example, the user singing data is input to the user terminal 3, and the user singing data is transmitted to the evaluation data supply device 2 via the user terminal communication unit 3A. The user singing data is received by the communication unit 2A. The evaluation data supply device 2 generates the evaluation F0 by performing processing similar to that of the first embodiment. Then, the evaluation data supply device 2 transmits the generated evaluation F0 to the user terminal 3 via the communication unit 2A.

The evaluation F0 is received by the user terminal communication unit 3A. The user terminal 3 generates the evaluation F0 by performing processing similar to that of the first embodiment. The user terminal 3 compares the user singing data with the evaluation F0, and notifies the user of the singing evaluation based on the comparison result and the singing expression data by performing the process similar to that of the first embodiment.

For example, the functions of the comparison unit 16 and the user singing evaluation unit 17 included in the user terminal 3 can be provided as an application that can be installed in the user terminal 3.

Note that, in a case where the above processing is performed in real time on the user's singing, the user singing data is stored in the buffer memory or the like until the evaluation F0 is transmitted from the evaluation data supply device 2.

### Modification

Although the embodiments of the present disclosure have been specifically described above, the present disclosure is not limited to the above-described embodiments, and various modifications based on the technical idea of the present disclosure can be made.

In the above-described embodiments, the evaluation data generation unit 15 generates the evaluation data by selecting the predetermined evaluation F0 from the plurality of evaluation F0 candidates, but is not limited to the selection. For example, the evaluation F0 may be directly generated from the original music data and the F0 likelihood using the singing F0 of the user subjected to the rounding processing. For example, the evaluation F0 may be estimated while the range in which the search for F0 is performed is restricted to the range (for example, about ±3 half-tones) around the singing F0 of the user to which the rounding processing is performed. As a method of estimating the evaluation F0, for example, a method of extracting F0 corresponding to the maximum value of the F0 likelihood whose range is restricted as described above as the evaluation F0 or a method of estimating the evaluation F0 from the acoustic signal by an autocorrelation method can be applied.

The data referred to in generating the evaluation F0 (first user input data) and the data to be evaluated (second user input data) are the same data, that is, the singing F0 of the user, but the present invention is not limited thereto. For example, the second user input data may be the user singing data corresponding to the current user's singing, and the first user input data may be the user's singing input before the current user's singing. In this case, the evaluation F0 may be generated by user singing data corresponding to previous user's singing. Then, the current user singing data may be evaluated using the previously-generated evaluation F0. The evaluation F0 generated in advance may be stored in the storage unit of the information processing device 1 or may be downloaded from an external device when the singing evaluation is performed.

In the above-described embodiments, the comparison unit 16 performs the comparison processing in real time, but the present invention is not limited thereto. For example, the singing F0 and the evaluation F0 may be accumulated after the start of the user's singing, and the comparison processing may be performed after the end of the user's singing. Furthermore, in the above embodiments, the singing F0 and the evaluation F0 are compared in units of one frame. However, the unit of processing can be changed as appropriate such that the singing F0 and the evaluation F0 are compared in units of several frames or the like.

In the above-described embodiments, the vocal signal is obtained by the sound source separation, but the sound source separation processing may not be performed on the original music data. However, in order to obtain an accurate feature amount, a configuration in which sound source separation is performed before the first feature amount extraction unit 12 is preferable.

In a karaoke system, sometimes the change information such as the pitch change, the tempo change, and the like can be set to the original musical composition. Such change information is set as performance meta information. In a case where the performance meta information is set, the pitch change processing or the tempo change processing may be performed on each of the evaluation F0 candidates on the basis of the performance meta information. Then, the singing F0 subjected to the pitch change and the like may be compared with the evaluation F0 candidate subjected to the pitch change and the like.

In the above-described embodiments, F0 is used as the evaluation data, but other frequencies and data may be used as the evaluation data.

A machine learning model obtained by machine learning in each processing described above may be applied. Furthermore, the user may be a user who uses a device and may not be an owner of the device.

Furthermore, one or a plurality of arbitrarily selected aspects of the above-described embodiments and modifications can be appropriately combined. Furthermore, the configurations, methods, steps, shapes, materials, numerical values, and the like of the above-described embodiments can be combined with each other without departing from the gist of the present disclosure.

Note that the present disclosure can also have the following configurations.

(1)

An information processing device including
a comparison unit that compares evaluation data generated on the basis of first user input data with second user input data.

(2)

The information processing device according to (1), further including
an evaluation unit that evaluates user input data on the basis of a comparison result of the comparison unit.

(3)

The information processing device according to (1),
in which the first user input data and the second user input data are same user input data, and
the comparison unit compares the evaluation data with the second user input data in real time.

(4)

The information processing device according to (1),
in which the first user input data and the second user input data are same user input data, and
the comparison unit compares the evaluation data with the second user input data after input of the second user input data is completed.

(5)

The information processing device according to any one of (1) to (4),
in which the first user input data is data input temporally before the second user input data.

(6)

The information processing device according to any one of (1) to (5),
in which the evaluation data is supplied from an external device.

(7)

The information processing device according to any one of (1) to (5), further including
a storage unit in which the evaluation data is stored.

(8)

The information processing device according to any one of (1) to (7),
in which the first user input data and the second user input data are any one of user's singing data, user's utterance data, or user's performance data.

(9)

The information processing device according to (2), further including
a notification unit that provides notification of evaluation by the evaluation unit.

(10)

An information processing method
in which a comparison unit compares evaluation data generated on the basis of first user input data with second user input data.

(11)

A program for causing a computer to execute an information processing method
in which a comparison unit compares evaluation data generated on the basis of first user input data with second user input data.

(12)

An information processing device including:
a feature amount extraction unit that extracts a feature amount of user input data; and
an evaluation data generation unit that generates evaluation data for evaluating the user input data on the basis of the feature amount of the user input data.

(13)

The information processing device according to (12), further including:
a sound source separation unit that separates data of a same type as the user input data from mixed sound data by performing sound source separation on the mixed sound data including the data of the same type as the user input data; and
an evaluation data candidate generation unit that generates a plurality of evaluation data candidates on the basis of a feature amount of the data separated by the sound source separation unit,
in which the evaluation data generation unit generates the evaluation data by selecting one evaluation data from the plurality of evaluation data candidates on the basis of the feature amount of the user input data.

(14)

The information processing device according to (13), further including:
a comparison unit that compares the user input data with the evaluation data; and
an evaluation unit that evaluates the user input data on the basis of a comparison result by the comparison unit.

(15)

The information processing device according to (14), further including
a notification unit that provides notification of evaluation by the evaluation unit.

(16)

An information processing method
in which a feature amount extraction unit extracts a feature amount of user input data, and
an evaluation data generation unit generates evaluation data for evaluating the user input data on the basis of the feature amount of the user input data.

(17)

A program for causing a computer to execute an information processing method
in which a feature amount extraction unit extracts a feature amount of user input data, and
an evaluation data generation unit generates evaluation data for evaluating the user input data on the basis of the feature amount of the user input data.

### Application Example

Next, application examples of the present disclosure will be described. In the embodiments described above, the user singing data is described as an example of the user input data, but other data may be used. For example, the user input data may be performance data (hereinafter, referred to as user performance data) of a musical instrument of the user, or may be a device by which the information processing device 1 evaluates the performance of the user. In this case, examples of the user performance data include performance data obtained by collecting the performance of the musical instrument and performance information such as MIDI transmitted from an electronic musical instrument or the like. Furthermore, the tempo of performance (for example, drum performance) and the timing of striking may be evaluated.

The user input data may be utterance data. For example, the present disclosure can also be applied to practice a specific line from among a plurality of lines. By applying the present disclosure, since a specific line can be used as evaluation data, it is possible to correctly evaluate the user's line practice. The present invention can be applied not only to line practice but also to practice of a foreign language imitating a specific speaker by using data in which a plurality of speakers is mixed.

The user input data is not limited to audio data, and may be image data. For example, the user performs dance practice while viewing image data of a dance performed by a plurality of dancers (for example, a main dancer and a back dancer). Image data of the user's dance is captured by the camera. For example, feature points (joints of the body and the like) of the user and the dancer are detected by a known method on the basis of the image data. A dance of a dancer having a feature point that moves similar to the movement of the detected feature point of the user is generated as evaluation data. The dance of the dancer corresponding to the generated evaluation data and the dance of the user are compared, and an evaluation is made on proficiency of the dance. As described above, the present disclosure can be applied to various fields.

### REFERENCE SIGNS LIST

1 Information processing device
15 Evaluation data generation unit
16 Comparison unit
17 User singing evaluation unit

1. An information processing device comprising
a comparison unit that compares evaluation data generated on a basis of first user input data with second user input data.

2. The information processing device according to claim 1, further comprising
an evaluation unit that evaluates user input data on a basis of a comparison result of the comparison unit.

3. The information processing device according to claim 1,
wherein the first user input data and the second user input data are same user input data, and
the comparison unit compares the evaluation data with the second user input data in real time.

4. The information processing device according to claim 1,
wherein the first user input data and the second user input data are same user input data, and
the comparison unit compares the evaluation data with the second user input data after input of the second user input data is completed.

5. The information processing device according to claim 1,
wherein the first user input data is data input temporally before the second user input data.

6. The information processing device according to claim 1,
wherein the evaluation data is supplied from an external device.

7. The information processing device according to claim 1, further comprising
a storage unit in which the evaluation data is stored.

8. The information processing device according to claim 1,
wherein the first user input data and the second user input data are any one of user's singing data, user's utterance data, or user's performance data.

9. The information processing device according to claim 2, further comprising
a notification unit that provides notification of evaluation by the evaluation unit.

10. An information processing method
wherein a comparison unit compares evaluation data generated on a basis of first user input data with second user input data.

11. A program for causing a computer to execute an information processing method
wherein a comparison unit compares evaluation data generated on a basis of first user input data with second user input data.

12. An information processing device comprising:
a feature amount extraction unit that extracts a feature amount of user input data; and
an evaluation data generation unit that generates evaluation data for evaluating the user input data on a basis of the feature amount of the user input data.

13. The information processing device according to claim 12, further comprising:
a sound source separation unit that separates data of a same type as the user input data from mixed sound data by performing sound source separation on the mixed sound data including the data of the same type as the user input data; and
an evaluation data candidate generation unit that generates a plurality of evaluation data candidates on a basis of a feature amount of the data separated by the sound source separation unit,
wherein the evaluation data generation unit generates the evaluation data by selecting one evaluation data from the plurality of evaluation data candidates on a basis of the feature amount of the user input data.

14. The information processing device according to claim 13, further comprising:
a comparison unit that compares the user input data with the evaluation data; and
an evaluation unit that evaluates the user input data on a basis of a comparison result by the comparison unit.

15. The information processing device according to claim 14, further comprising
a notification unit that provides notification of evaluation by the evaluation unit.

16. An information processing method
wherein a feature amount extraction unit extracts a feature amount of user input data, and
an evaluation data generation unit generates evaluation data for evaluating the user input data on a basis of the feature amount of the user input data.

17. A program for causing a computer to execute an information processing method
wherein a feature amount extraction unit extracts a feature amount of user input data, and
an evaluation data generation unit generates evaluation data for evaluating the user input data on a basis of the feature amount of the user input data.
